(19) United States
(12) Patent Application Publication
(10) Pub. No.: US 2002/0010099 A1
(43) Pub. Date: Jan. 24, 2002

(54) Combinations of crop protection agents with anionic polymers

(76) Inventors: Gerhard Frisch, Wehrheim (DE); Udo Bickers, Wietmarschen (DE); Keith Andrew Young, Franchville (FR); Erwin Hacker, Hochheim (DE); Gerhard Schnabel, Elsenfield (DE)

Correspondence Address: FROMMER LAWRENCE & HAUG LLP, 745 Fifth Avenue, New York, NY, 10151, US

(21) Appl. No.: 09/852,106

(22) Filed: May 9, 2001

(30) Foreign Application Priority Data
May 11, 2000 (DE) 100 22 986.7

(51) Int. Cl. A01N 25/00

(52) U.S. Cl. 504/358; 514/788

(57) ABSTRACT

The present invention relates to a combination of a cationic agrochemically active compound with an anionic polymer having negatively charged functional groups, with formation of electrostatic interactions for the controlled release of this active compound. This combination permits the suppression of antagonistic interactions of various active compounds with one another, and also better crop selectivity.

The present invention relates to combinations of crop protection agents with polymeric anionic auxiliaries which permit a controlled release of an active compound. The combinations can be used to increase crop selectivities and to reduce antagonisms and give particularly good results in the case of herbicides, in particular in the case of mixtures of herbicides with growth regulators and safeners.

It is known that various application problems, reduced activity owing to antagonistic interactions between two or more active compounds and insufficient so-called crop compatibility and associated undesirable damage to the plants can occur during the application of various agrochemical products, for example herbicides, fungicides, insecticides, plant growth regulators, safeners or fertilizers. It is furthermore known that these phenomena are frequently observed during so-called foliar application, and again in particular in the case of herbicides or else of mixtures of herbicides with safeners and/or growth regulators.

To avoid these problems, a so-called split application, for example, or an overdosage of the active compound that is antagonized has been recommended for cases of reduced activity owing to antagonism. In cases of poor selectivity or insufficient crop compatibility, it is often likewise possible to use split application; an alternative option is underdosage. However, for various reasons, all of these procedures are rather unattractive and uneconomical. When using split application, the active compound formulation has to be applied at least twice; this is time-consuming and labor-intensive. Overdosage of an active compound results in additional expenditure, underdosage involves the risk of reduced yields owing to insufficient control of harmful organisms.

U.S. Pat. No. 5,428,000 discloses active compound compositions comprising a herbicide for broad-leaved weeds and a herbicide for weed grasses. The herbicide for weed grasses has a neutral charge; in contrast, the herbicide for broad-leaved weeds is of anionic nature and is present in combination with a hydrophilic polymer, the polymer being a copolymer formed from an ammonium-containing compound and a compound which does not contain any ammonium. The ammonium-containing compound is generally derived from aromatic and nonaromatic nitrogen heterocycles, ammonium derivatives of acrylic acid and benzylammonium compounds. Thus, the polymers are exclusively polymers in which the quaternary nitrogen atom is not contained in the main chain of the polymer. The hydrophilic polymers used are exclusively copolymers of the abovementioned type. The herbicides for weed grasses used are sethoxydim, alloxidim, fluazifop, quizalofop or fenoxaprop; for broad-leaved weeds, the use of bentazone, imazaquin, acifluorfen, fomesafen, chlorimuron, imazethapyr, thifensulfuron and 2,4-D has been described.

DE 198 33 066 discloses aqueous dispersions of polymers with cationic functionality and redispersible powders obtainable from the dispersions, and also their use, inter alia for the delayed release of active compounds of any kind.

It is an object of the present invention to provide formulations of crop protection agents which render the requirement of split applications and overdosage or underdosage obsolete.

This object is achieved by a combination of at least one agrochemically active compound having cationic functional groups, in particular a herbicide, with a anionic polymer with formation of electrostatic interaction between these components for the controlled release of this active compound.

It has been found that problems such as poor selectivity and insufficient crop compatibility or reduced activity caused by antagonism can be avoided by combining certain anionic polymers with one or more agrochemically active compounds.

The present invention furthermore provides the application of the combination according to the invention for controlling undesirable harmful organisms, in particular undesirable grasses and broad-leaved weeds.

In the present invention, the term “polymer” includes both oligomers and polymers and also homo- and copolymers or -oligomers of the corresponding monomers, i.e. molecules having a low degree of polymerization and also those having a high degree of polymerization. The molecular weights M_{N} of the compounds which can be used according to the invention as polymers are at least 500.

In the polymer/active compound combination according to the invention, some or all of the agrochemically active compound enters into an attractive reversible intermolecular interaction with the oligomer or polymer. These interactions are electrostatic interactions. The agrochemically active compound can be an active compound having partial selectivity. Alternatively, it is also possible for an active compound which, in an intended active compound mixture, shows antagonistic action, to interact with the polymer. It is also possible for two or more active compounds in an active compound mixture to enter into such an interaction.

The anionic polymers used according to the invention can also be surface-active molecules. Owing to their physicochemical properties, they can be dispersed, emulsified or dissolved in water and/or organic solvents. The polymers are preferably dissolved, the preferred solvents being polar protic and polar aprotic organic solvents and water. Most preferably, the polymers dissolve in water.

Polymers suitable for the combinations according to the invention preferably penetrate only slowly, if at all, into the harmful organism, penetration generally taking place, for example, via the leaf or the root. In general, the absorption rate or penetration rate of the polymers used according to the invention is between<0.01% and 80%, preferably considerably less than 50%, in 24 hours.

The polymers used according to the invention have negatively charged functional groups. In general, the mean molecular weight M_{N} of the polymers used according to the invention is≧500, preferably from about 1 000 to 1 000 000. These polymers in question can be homo- or copolymers and are produced in customary polymerization reactions, for example polyadditions, polycondensations, free-radical and ionic polymerizations and metal-complex-catalyzed polymerizations. Also suitable are modified or unmodified natural polymers, for example oligo- and polypeptides and oligo- and polysaccharides.

Suitable negatively charged functional groups are carboxylate (COO^{⊖}), sulfonate (SO₃^{⊖}), sulfate (OSO₃^{⊖}), phosphonate (P(O)O₂²⁻, P(O)ORO^{⊖}) and phospate groups (OP(O)O₂^{2⊖}, OP(O)ORO^{⊖}).

Suitable polymers which may contain the abovementioned functional groups are polymers of organic nature, for example lignins and polymers based on allyl, (meth)acryl and vinyl monomers and polymers of inorganic nature, for example silicates.

Examples of preferred polymers include sulfonized and sulfatized lignin, polyacrylates, polymethacrylates, polyvinyl acetate, polycarbonates, polyesters, polyaspartates, phospholipids and polysaccharides.

Further suitable anionic polymers are known to the person skilled in the art. In general, commercial products will be employed.

Agrochemically active compounds which are suitable for the present invention have functional groups which are positively charged or carry a positive partial charge and can be converted into cationic functions. It is also possible for the active compounds to be present as cations even before formulation. However, it is also possible that these active compounds are converted into cations only during the formulation or the preparation of the so-called tank mix, for example by protonation or by abstraction of groups or counterions during these processes.

Cationic active compounds suitable for use in the combinations according to the invention are those which belong to the group of the herbicides, fungicides, insecticides, growth regulators, safeners, acaricides, molluscicides and nematicides.

Particularly suitable for combination with the polymers containing anionic functions are herbicides, among these in particular glufosinate, glyphosate, paraquat, diquat, difenzoquat, metilsulfat, mepiquat, chlormequat and bialaphos. The abovementioned active compounds can, if appropriate, be present in the form of the derivatives known to the person skilled in the art, such as salts, for example in the customary known quaternized form, which is shown in the literature on the subject, such as, for example, in “The Pesticide Manual”, C D S Tomlin Ed., British Crop Protection Council, Farnham (GB), 1997.

The combinations according to the invention permit the phytotoxic potential of active compounds to be reduced and antagonization of other active compounds in mixtures with the former to be suppressed. Active compounds to be combined according to the invention can therefore be used together with other active compounds or as sole active compound, if appropriate together with customary additives and adjuvants. Examples of preferred combinations according to the invention are described below. In all these combinations, the use of the active compounds described above as being particularly suitable or most suitable is, of course, likewise preferred, even if this is not explicitly mentioned.

The agrochemically active compounds combined with the polymers used according to the invention can be formulated with other active compounds which, if appropriate, are likewise combined with polymers according to the present invention, to afford mixtures giving advantageous results.

A preferred embodiment of the present invention are combinations in which some or all of an agrochemically active compound, for example a herbicide, is combined according to the invention with an anionic polymer, the combination additionally comprising at least one further agrochemically active compound, for example a herbicide or safener.

In a further preferred embodiment of the present invention, herbicides with safeners and/or growth regulators are formulated in combination with the polymers used according to the invention, where at least one of the agrochemically active compounds has been combined according to the invention with these polymers.

It is furthermore preferred to combine one or more herbicides having a rapid mechanism of action with one or more herbicides having a relatively slow mechanism of action, where at least one of the agrochemically active compounds has been combined according to the invention.

Further preferred embodiments are herbicidal mixtures comprising the combination glufosinate/paraquat, glufosinate/diquat, glyphosate/paraquat or glyphosate/diquat, where at least one of the agrochemically active compounds has been combined according to the invention.

In a further preferred embodiment, one or more graminicides are mixed with a safener and optionally a plant growth regulator, where at least one of the agrochemically active compounds has been combined according to the invention.

In the combinations according to the invention, the weight ratio of polymer to cationic active compound or compounds is, depending on the molecular weight of the monomer and the active compound and on other physicochemical parameters known to the person skilled in the art, from 0.001:1 to 1:0.001, preferably from 0.01:1 to 1:0.01, most preferably from 0.1:1 to 1:0.1.

In many cases, it is advantageous to add adjuvants, for example oils, special solvents, surfactants or surfactant mixtures. Here, adjuvants are to be understood as meaning those additives to active compound/polymer combinations which are not active themselves but enhance the properties of the active compound. Suitable adjuvants are nonionic surfactants, for example those of the formula RO(CH₂CH₂O)ₙH, in which R is a (C₁₀-C₂₂)-fatty alcohol radical, a tristyrylphenol radical, a butylphenol radical, a (C₁-C₁₄)-alkylphenol radical, a tridecyl alcohol radical, a glyceride radical or a radical derived from castor oil and n is an integer of from 1 to 500, preferably from 3 to 200.

Such substances are obtainable, for example, as Genapol®, Sapogenat® and Arkopal® series from Clariant GmbH and as Soprophor® series from Rhodia GmbH. It is also possible to employ block copolymers based on ethylene oxide, propylene oxide and/or butylene oxide, for example the compounds sold by BASF AG under the names Pluronics® or Tetronics®.

Anionic or betainic surfactants, too, can be used. Examples of anionic surfactants include calcium dodecylbenzylsulfonate, succinates, phosphated, sulfated and sulfonated nonionic surfactants, for example those of the type mentioned above, and sorbitates, these anionic compounds being neutralized with alkali metal, alkaline earth metal or ammonium ions. Such surfactants are available, for example, under the name Genapol® LRO (Clariant GmbH).

Betainic surfactants are obtainable, for example, from Goldschmidt AG under the name Tegotain®.

Also suitable are cationic surfactants, for example those based on quaternary ammonium, phosphonium and tertiary sulfonium salts, for example Atlas® G3634 A from Uniquema.

The amount of surfactant used is from 10 to 2 000 g/ha, preferably from 50 to 2 000 g/ha. The addition of nitrogen, for example in the form of urea, ammonium nitrate, ammonium sulfate, ammonium hydrogen sulfate or mixtures thereof, is likewise often advantageous.

Formulations comprising combinations according to the invention are described in an exemplary manner below.

It is possible to use glufosinate (250-500 g/ha) with paraquat (10-400 g/ha) together with polyacrylates (1-500 g/ha) to increase the total herbicidal action compared to a combination of the two active compounds without a suitable polymer.

To prevent a reduced action owing to antagonistic interactions, it is possible to combine mixtures of glufosinates with diquat or paraquat with known polymers of the Geropon® type from Rhodia GmbH or of the Reax® type from Westvaco.

Further substances which may optionally be present are safeners, other herbicides, adjuvants such as, for example, Genapol® LRO or fertilizers such as, for example, ammonium sulfate, ammonium hydrogen sulfate, urea or ammonium nitrate.

To prevent a reduced action owing to antagonistic interactions, it is possible to combine mixtures of glyphosates with diquat or paraquat with known polymers of the Geropon® type from Rhodia GmbH or of the Reax® type from Westvaco. Further substances which may optionally be present are safeners, other herbicides, adjuvants such as, for example, Genapol® LRO or fertilizers such as, for example, ammonium sulfate, ammonium hydrogen sulfate, urea or ammonium nitrate.

The percentage of the active compounds in the various formulations can be varied within wide ranges. The formulations comprise, for example, from about 0.1 to 95% by weight of active compounds, about 90-10% by weight of liquid or solid carriers and, if appropriate, up to 50% by weight, preferably up to 30% by weight, of surfactants, where the sum of these percentages should be 100%.

The mixtures, prepared according to the invention, of polymer, one or more active compounds and optional adjuvants and other auxiliaries can also be present as a separate tank mix, and also in other formulatons.

Suitable possible formulations are, for example:

wettable powders (WP), water-soluble powders (SP), suspension concentrates (SC) based on oil or water, water-soluble concentrates (SL), emulsifiable concentrates (EC), micro- and macroemulsions (EW/ME), such as oil-in-water and water-in-oil emulsions, sprayable solutions, suspension emulsions (SE), oil-miscible solutions, capsule suspensions (CS), dusts (DP), seed-dressing compositions, granules for broadcasting and soil application, granules (GR) in the form of microgranules, spray granules, coating granules and adsorption granules, water-dispersible granules (WDG), water-soluble granules (WSG), ULV formulations, microcapsules and waxes. These individual formulation types are known in principle and are described, for example, in Winnacker-Küchler, “Chemische Technologie” [Chemical Technology], Volume 7, C. Hanser Verlag Munich, 4th Edition, 1986; Wade van Valkenburg, “Pesticide Formulations”, Marcel Dekker, N.Y., 1973; K. Martens, “Spray Drying” Handbook, 3^{rd} Ed. 1979, G. Goodwin Ltd. London.

Formulation auxiliaries, such as inert materials, surfactants, solvents and other additives, are likewise known and are described, for example, in Watkins, “Handbook of Insecticide Dust Diluents and Carriers”, 2^{nd} Ed., Darland Books, Caldwell N.J., H. v. Olphen, “Introduction to Clay Colloid Chemistry”, 2^{nd} Ed., J. Wiley & Sons, N.Y.; C. Marsden, “Solvents Guide”, 2^{nd} Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte [Surface-Active Ethylene Oxide Adducts]”, Wiss. Verlagsgesell., Stuttgart 1976; Winnacker-Küchler, “Chemische Technologie”, Volume 7, C. Hanser Verlag Munich, 4th Edition 1986.

Wettable powders are preparations which are uniformly dispersible in water and which contain, in addition to the combination according to the invention and as well as a diluent or inert substance, surfactants of ionic and/or nonionic nature (wetting agents, dispersants), for example polyethoxylated alkylphenols, polyethoxylated fatty alcohols, polyethoxylated fatty amines, fatty alcohol polyglycol ether sulfates, alkanesulfonates, alkylbenzenesulfonates, sodium lignosulfonate, sodium 2,2′-dinaphthylmethane-6,6′-disulfonate, sodium dibutyinaphthalenesulfonate or else sodium oleoylmethyltaurinate. To prepare the wettable powders, the active compounds are finely ground in customary apparatus such as hammer mills, fan mills or air-jet mills, and are mixed simultaneously or subsequently with the formulation auxiliaries and also the polymers used according to the invention.

Emulsifiable concentrates are prepared by dissolving the active compounds in combination with the polymer in an organic solvent, for example butanol, cyclohexanone, dimethylformamide, xylene or else relatively high-boiling aromatic compounds or hydrocarbons or mixtures of the organic solvents, with the addition of one or more surfactants of ionic and/or nonionic nature (emulsifiers). Examples of emulsifiers which can be used are calcium alkylarylsulfonates, such as calcium dodecylbenzenesulfonate, or nonionic emulsifiers, such as alkylaryl polyglycol ethers different from para-alkylphenol ethoxylates, fatty acid polyglycol esters, fatty alcohol polyglycol ethers, propylene oxide-ethylene oxide condensation products, alkyl polyethers, sorbitan esters, for example sorbitan fatty acid esters, or polyoxyethylene sorbitan esters, for example polyoxyethylene sorbitan fatty acid esters.

Dusts are obtained by grinding the active compound in combination with polymers to be used according to the invention with finely divided solid substances, for example, talc, natural clays, such as kaolin, bentonite and pyrophillite, or diatomaceous earth.

Suspension concentrates can be water- or oil-based. They can be prepared, for example, by wet milling using commercially customary bead mills, with or without the addition of surfactants as already mentioned above under the other formulation types.

Emulsions, for example oil-in-water emulsions (EW), can be prepared, for example, by means of stirrers, colloid mills and/or static mixers using aqueous organic solvents and, if desired, surfactants, for example as already mentioned above under the other formulation types.

Granules can be prepared either by spraying the active compound in combination with the polymer to be used according to the invention onto adsorptive, granulated inert material or by applying the combination to the surface of carriers, such as sand, kaolinites or of granulated inert material, by means of adhesives, for example sugars, such as pentoses and hexoses and also mineral oils. Suitable active compounds in combination with the polymer to be used according to the invention can also be granulated in the manner which is customary for the preparation of fertilizer granules, if desired as a mixture with fertilizers.

Water-dispersible granules are generally prepared by the customary processes, such as spray-drying, fluidized-bed granulation, disk granulation, mixing using high-speed mixers, and extrusion without solid inert material.

For the preparation of disk, fluidized-bed, extruder and spray granules, see, for example, the processes in “Spray-Drying Handbook” 3^{rd} Ed. 1979, G. Goodwin Ltd., London; J. E. Browning, “Agglomeration”, Chemical and Engineering 1967, pages 147 ff.; “Perry's Chemical Engineer's Handbook”, 5^{th} Ed., McGraw-Hill, New York 1973, pp. 8-57.

For further details on the formulation of crop protection products, see, for example, G. C. Klingman, “Weed Control as a Science”, John Wiley and Sons, Inc., New York, 1961, pages 81-96 and J. D. Freyer, S. A. Evans, “Weed Control Handbook”, 5^{th} Ed., Blackwell Scientific Publications, Oxford, 1968, pages 101-103.

In addition, said formulations of the combinations according to the invention may comprise the tackifiers, wetting agents, dispersants, emulsifiers, penetrants, preservatives, antifreeze agents, solvents, fillers, carriers, colorants, antifoams, evaporation inhibitors and pH and viscosity regulators which are customary in each case.

Based on these formulations, it is also possible to prepare mixtures with other pesticidally active compounds, such as herbicides, insecticides, fungicides, and also antidotes or safeners, fertilizers and/or growth regulators, for example in the form of a finished formulation or for use as tank mixes.

The combinations according to the invention have outstanding activity. If herbicides are combined with polymers to give the combinations according to the invention, the combinations have excellent herbicidal activity against a broad spectrum of economically important monocotyledonous and dicotyledonous harmful plants. The active compound combinations also act efficiently on perennial weeds which produce shoots from seeds or rhizomes, root stocks or other perennial organs and which are difficult to control. In this context, it is immaterial whether the combinations according to the invention are applied pre-sowing, pre-emergence or post-emergence. The combinations according to the invention are preferably applied onto above-ground parts of plants. The combinations according to the invention are also suitable for dessicating crop plants such as potato, cotton and sunflower.

In the case of herbicidally active compounds, the combinations according to the invention can be used, for example, for controlling the following harmful plants:

Dicotyledonous weeds of the genera Sinapis, Galium, Stellaria, Matricaria, Galinsoga, Chenopodium, Brassica, Urtica, Senecio, Amaranthus, Portulaca, Xanthium, Convolvulus, Ipomoea, Polygonum, Sesbania, Cirsium, Carduus, Sonchus, Solanum, Lamium, Veronica, Abutilon, Datura, Viola, Monochoria, Commalina, Sphenoclea, Aeschynomene, Heteranthera, Papaver, Euphorbia and Bidens.

Monocotyledonous weeds of the genera Avena, Alopecurus, Echinochloa, Setaria, Panicum, Digitaria, Poa, Eleusine, Brachiaria, Lolium, Bromus, Cyperus, Elytrigia, Sorphum, Apera and Scirpus.

If the herbicidal compositions which comprise the combinations according to the invention are applied prior to germination, then the weed seedlings are either prevented completely from emerging, or the weeds grow until they have reached the cotyledon stage but then their growth stops, and, eventually, after three to four weeks have elapsed, they die completely.

If the herbicidal compositions which comprise the combinations according to the invention are applied post-emergence to the green parts of the plants, growth also stops drastically a very short time after the treatment and the weed plants remain at the development stage of the point in time of application, or they die completely after a certain time, more or less rapidly, so that in this manner competition by the weeds, which is harmful to the crop plants, is eliminated at a very early point in time and in a sustained manner by employing the novel combinations according to the invention, as are associated quantitative and qualitative losses in yield.

Although these combinations according to the invention have excellent herbicidal activity against monocotyledonous and dicotyledonous weeds, damage to the crop plant is insignificant, if there is any damage at all.

These effects allow, inter alia, the application rate to be reduced, a broader spectrum of broad-leaved weeds and weed grasses to be controlled, activity gaps to be closed, also with respect to resistant species, more rapid and safer action, longer duration of action, complete control of the harmful plants using only one or a few applications, and a prolonged application period if a plurality of active compounds are present at the same time.

The abovementioned properties are required for weed control in practice to keep agricultural crops free of undesirable competing plants and to safeguard and/or increase yield quality and quantity. With respect to the properties described, the combinations according to the invention are considerably superior to the prior art. In addition, the combinations according to the invention permit, in an excellent manner, the control of otherwise resistant harmful plants.

Owing to their agrochemical properties, preferably herbicidal, plant-growth-regulatory and safener properties, the combinations according to the invention, which are preferably employed in herbicidal compositions, can also be employed for controlling harmful plants in crops of known or still to be developed genetically engineered plants. The transgenic plants generally have particularly advantageous properties, for example resistance to certain pesticides, in particular certain herbicides, resistance to plant diseases or causative organisms of plant diseases, such as certain insects or microorganisms such as fungi, bacteria or viruses. Other particular properties relate, for example, to the quantity, quality, storage-stability, composition and to specific ingredients of the harvested product. Thus, transgenic plants having an increased starch content or a modified quality of the starch or those having a different fatty acid composition of the harvested product are known.

The use of the combinations according to the invention in economically important transgenic crops of useful and ornamental plants, for example of cereal, such as wheat, barley, rye, oats, millet, rice, manioc and corn, or else in crops of sugar beet, cotton, soya, oilseed rape, potato, tomato, pea and other vegetable species is preferred.

The combinations according to the invention can preferably be used in herbicides in crops of useful plants which are resistant or which have been made resistant by genetic engineering toward the phytotoxic effects of the herbicides.

Conventional ways for preparing novel plants which have modified properties compared to known plants comprise, for example, traditional breeding methods and the generation of mutants. Alternatively, novel plants having modified properties can be generated with the aid of genetic engineering methods (see, for example, EP-A-0 221 044, EP-A-0 131 624). For example, there have been described several cases of

genetically engineered changes in crop plants in order to modify the starch synthesized in the plants (for example WO 92/11376, WO 92/14827, WO 91/19806),

transgenic crop plants which are resistant to certain herbicides of the glufosinate (cf., for example, EP-A-0 242 236, EP-A-0 242 246) or glyphosate (WO 92/00377) or sulfonylurea (EP-A-0 257 993, U.S. Pat. No. 5,013,659) type,

transgenic crop plants, for example cotton, having the ability to produce Bacillius thuringiensis toxins (Bt toxins) which impart to the plants resistance to certain pests (EP-A-0 142 924, EP-A-0 193 259),

transgenic crop plants having a modified fatty acid composition (WO 91/13972).

Numerous molecular biological techniques which allow the preparation of novel transgenic plants having modified properties are known in principle; see, for example, Sambrook et al., Molecular Cloning, A Laboratory Manual, 2nd Ed. Cold Spring Harbor Laboratory Press, Cold Spring Harbor, N.Y., or Winnacker “Genes and Clones”, V C H Weinheim 2nd Edition 1996 or Christou, “Trends in Plant Science” 1 (1996) 423-431.

In order to carry out such genetic engineering manipulations, it is possible to introduce nucleic acid molecules into plasmids which allow a mutagenesis or a change in the sequence to occur by recombination of DNA sequences. Using the abovementioned standard procedures, it is possible, for example, to exchange bases, to remove partial sequences or to add natural or synthetic sequences. To link the DNA fragments to one another, it is possible to attach adapters or linkers to the fragments.

Plant cells having a reduced activity of a gene product can be prepared, for example, by expressing at least one appropriate antisense-RNA, a sense-RNA to achieve a cosuppression effect, or by expressing at least one appropriately constructed ribozyme which specifically cleaves transcripts of the abovementioned gene product.

To this end, it is possible to employ either DNA molecules which comprise the entire coding sequence of a gene product including any flanking sequences that may be present, or DNA molecules which comprise only parts of the coding sequence, it being necessary for these parts to be long enough to cause an antisense effect in the cells. It is also possible to use DNA sequences which have a high degree of homology to the coding sequences of a gene product but which are not entirely identical.

When expressing nucleic acid molecules in plants, the synthesized protein can be localized in any desired compartment of the plant cell. However, to achieve localization in a certain compartment, it is, for example, possible to link the coding region with DNA sequences which ensure localization in a certain compartment. Such sequences are known to the person skilled in the art (see, for example, Braun et al., EMBO J. 11 (1992), 3219-3227; Wolter et al., Proc. Natl. Aca. Sci. USA 85 (1988), 846-850; Sonnewald et al., Plant J. 1 (1991), 95-106).

The transgenic plant cells can be regenerated through whole plants using known techniques. The transgenic plants can in principle be plants of any desired plant species, i.e. both monocotyledonous and dicotyledonous plants. In this manner, it is possible to obtain transgenic plants which have modified properties by overexpression, suppresion or inhibition of homologous (=natural) genes or gene sequences or by expression of heterologous (=foreign) genes or gene sequences.

The combinations according to the invention can preferably be used in transgenic crops which are resistant to herbicides from the group consisting of the sulfonylureas, glufosinate-ammonium or glyphosate-isopropylammonium and analogous active compounds.

When using the combinations according to the invention, in particular those in herbicidal compositions, in transgenic crops, in addition to the effects against harmful plants which can be observed in other crops, there are frequently effects which are specific for the application in the respective transgenic crop, for example a modified or specifically broadened spectrum of weeds which can be controlled; modified application rate which can be used for the application; preferably good miscibility or combinability with the herbicides to which the transgenic crops are resistant; and an effect on the growth and the yield of the transgenic crop plants.

The invention is now additionally illustrated in the examples below.

In all examples, seeds or rhizome pieces of mono- and dicotyledonous harmful plants and useful plants were placed in sandy loam soil in pots having a diameter of 9-13 cm and covered with soil. The pots were kept in a greenhouse under optimum conditions. In the two-leaf to three-leaf stage, i.e. about 3 weeks after start of cultivation, the test plants were treated with the combinations according to the invention in the form of aqueous dispersions or suspensions or emulsions and sprayed onto the green parts of the plant at various dosages, using a water application rate of 300 l/ha (converter). For further cultivation of the plants, the pots were kept in a greenhouse under optimum conditions. Visual scoring of the damage to useful plants and crop plants was carried out 2-3 weeks after the treatment.

### EXAMPLE 1

A mixture of glufosinate (300 g/ha) and diquat (50 g/ha) was combined with 30 g/ha of Geropon® T36 (from Rhodia GmbH) and, for desiccation, applied to crops of potatoes and sunflowers and in a so-called Liberty Link crop such as corn. Compared to the application of a mixture of glufosinate (300 g/ha) and diquat (50 g/ha), a considerably increased activity was observed.

### EXAMPLE 2

A mixture of glufosinate (300 g/ha) and diquat (50 g/ha) was combined with 60 g/ha of Geropon® T36 (from Rhodia GmbH) and, for desiccation, applied to crops of potatoes and sunflowers and in a so-called Liberty Link crop such as corn. Compared to the application of a mixture of glufosinate (300 g/ha) and diquat (50 g/ha), a considerably increased activity was observed.

### EXAMPLE 3

A mixture of glufosinate (300 g/ha) and diquat (50 g/ha) was combined with 90 g/ha of Geropon® T36 (from Rhodia GmbH) and, for desiccation, applied to crops of potatoes and sunflowers and in a so-called Liberty Link crop such as corn. Compared to the application of a mixture of glufosinate (300 g/ha) and diquat (50 g/ha), a considerably increased activity was observed.

1. A combination of at least one agrochemically active compound having cationic functional groups with an anionic polymer with formation of electrostatic interactions between these components.

2. The combination as claimed in claim 1, wherein the active compound is selected from the group consisting of herbicides, fungicides, insecticides, growth regulators, safeners, acaricides, molluscicides and nematicides, in particular from the group consisting of herbicides, safeners and plant growth regulators.

3. The combination as claimed in claim 2, wherein the herbicides are selected from the group consisting of glufosinate, glyphosate, paraquat, diquat, difenzoquat, metilsulfat, mepiquat, chlormequat and bialaphos and also quaternized forms, which are known per se, of these active compounds.

4. The combination as claimed in claim 3, wherein the polymer is soluble, dispersible and/or emulsifiable in water and/or organic solvents, preferably in polar protic and/or polar aprotic organic solvents and/or water, most preferably in water, and has an absorption rate or penetration rate of<50% in 24 h.

5. The combination as claimed in claim 1, wherein the molecular weight M_{N} Of the polymer is>500, preferably about 1 000 to 1 000 000, and the polymer is employed in a weight ratio to the active compound of from about 0.001:1 to about 1:0.001, preferably from 0.01:1 to 1:0.01, most preferably from 0.1:1 to 1:0.1.

6. The combination as claimed in claim 1, wherein the polymer has functional groups selected from carboxylate, sulfonate, sulfate or phosphonate groups, preferably from the group consisting of polyacrylates, polymethacrylates, sulfonated lignin, sulfated lignin, polyvinyl acetate, polycarbonates, polyesters, polyaspartates, phospholipids, polysaccharides and silicates.

7. A formulation, comprising a combination as claimed in claim 1 and at least one further component from the group consisting of further agrochemically active compounds, surfactants, fertilizers and customary adjuvants.

8. The formulation as claimed in claim 7, wherein a combination of a herbicide and an oligo- or polymer is present together with a safener and/or a growth regulator.

9. The use of a combination as claimed in claim 1 or of a formulation as claimed in claim 7 or 8 for suppressing antagonistic interactions during the application of one or more agrochemically active compounds for controlling harmful plants.

10. The use of a combination as claimed in claim 1 or of a formulation as claimed in claim 8 or 9 for increasing crop selectivity during the application of one or more agrochemically active compounds for controlling harmful plants.

11. A method for controlling harmful organisms, in particular harmful plants, which comprises applying in a manner known per se a combination as claimed in claim 1 or a formulation as claimed in claim 9 or 10.

12. A process for preparing a combination as claimed in claim 1 or a formulation as claimed in claim 8 or 9, which comprises combining the active compound by customary processes which are known per se, preferably by dissolving, stirring or mixing, with a suitable polymer, and introducing this combination into the formulation, if appropriate with other active compounds, adjuvants and additives.
